(19) United States
(12) Patent Application Publication
(10) Pub. No.: US 2006/0194535 A1
(43) Pub. Date: Aug. 31, 2006

(54) Broadcast delivery to a wireless device

(75) Inventors: Richard J. Houldsworth, Redhill (GB); Immo Benjes, Redhill (GB)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 10/551,313

(22) PCT Filed: Mar. 26, 2004
(86) PCT No.: PCT/IB04/00972

§ 371 Date: Sep. 28, 2005

(30) Foreign Application Priority Data
Apr. 3, 2003 (GB) 0307694.0

(51) Int. Cl. H04H 1/00

(52) U.S. Cl. 455/3.01

(57) ABSTRACT

A broadcast media receiver (30) enables delivery of application programs and other data streams transmitted over broadcast media transmission networks to mobile communication devices. The receiver includes a receiver unit for receiving a first data stream (21) of broadcast media and at least one second data stream (22) over a first communication channel (20); data separation means (33) for separating the second data stream (22) from the first data stream (21); a transmitter/receiver unit (41) for communicating with mobile communication devices (50, 51) within a local, short range, transient wireless network (40) using a second communication channel; a monitoring device (37) for detecting a mobile communication device present on the local wireless network, and for determining a device type and/or configuration thereof; and a delivery device (35, 41) for delivering a third data stream (23), comprising at least part of said second data stream (22), to said mobile communication device according to the determined device type and/or configuration.

The present invention relates generally to methods and apparatus for delivering application programs and other data to mobile communication devices such as mobile telephones, using a media receiver device such as a set top box (STB) coupled to a broadcast media transmission network.

Various broadcast media systems using digital video broadcasting (DVB), digital audio broadcasting (DAB) or conventional analogue transmission protocols are used to deliver media content such as television channels, radio channels and multimedia data content to users by way of broadcast networks. Typically, these broadcast networks comprise bi-directional or unidirectional cable, satellite and terrestrial broadcast communication channels.

These broadcast networks typically have a relatively high bandwidth making them suitable for downloading large quantities of data. Within the digital television standards, there are a variety of data transmission protocols, ranging from a simple continuous stream of data (eg. DVB data piping) to complex modelling of hierarchical file systems (eg. MPEG DSMCC object carousel (Motion Picture Experts Group Digital Storage Media Command and Control). Traditional analogue TV transmissions also support a limited data channel utilising the VBI (vertical blanking interrupt).

Conventionally, the data types delivered over these mechanisms is limited to specific applications designed for display on a television device—for example electronic program guides and general video text information services. Typically, a broadcast media receiver device such as a set-top box (STB) or integrated digital television (IDTV) will contain appropriate software to interpret the incoming data for display to the user. The built-in software on these devices is increasing in sophistication with general-purpose computing platforms such as the DVB multimedia home platform (MHP) offering to run a wider range of applications on these media receiver devices than ever before.

More recently, it has been proposed to use such broadcast networks as a means for delivering data to portable devices such as personal digital assistants (PDAs) or mobile telephones via a broadcast media receiver eg. a STB. Further, exploitation of new levels of connectivity between such media receivers and mobile devices using Bluetooth or IEEE 802.11 communication protocols has been proposed.

For example, US 2002/0056112 describes a broadcast media receiver or STB which is adapted to receive broadcast signal components including first data broadcasts such as television programs for use by a suitable television receiver, and second data broadcasts for use by personal digital assistants. The second data broadcasts may include application programs and control code, audio/video data streams, web pages and other data. The receiver communicates the second data broadcasts to a personal digital assistant using a short range wireless communication channel.

EP 1213842A describes a broadcast media receiver or STB which is adapted to allow remote control thereof by way of a mobile telephone handset. The receiver may download broadcast program schedule data to a user's mobile telephone, and may effect switching on and off of the television dependent upon the user's mobile telephone ID code.

EP 1259075A describes a method for broadcasting applications in a DVB network, in which web pages are broadcast over the DVB network using a divided browser system. A first processor at the transmission end of the broadcast network carries out a ‘heavy’ part of the browser processing (ie. that which requires high computation and/or memory capacity) and a second processor at the receiving end of the broadcast network carries out a ‘light’ part of the browser processing (ie. that which requires low computation and/or memory capacity). This enables the web browsing to be carried out effectively with only the ‘light’ browser part installed in a device having low processing or memory capability, such as a personal digital assistant, mobile telephone or set-top box.

WO 01/47248 describes a system for allowing remote access to a multimedia device in a home environment, in which a user may, using a remote device such as a mobile telephone or PDA, facilitate delivery of multimedia content from the multimedia home device to the user's remote device.

WO 01/80460 describes a method for controlling access to a media broadcast, by a broadcast media receiver (eg. set-top box. STB), using a mobile telephone network. A mobile telephone is connected to the STB using a short range wireless communication channel and a menu corresponding to the STB equipment and/or a digital television transmission is communicated to the mobile telephone. Decoding of a selected broadcast is enabled by delivery of decoding keys via the mobile telephone network.

It is an object of the present invention to provide improved functionality to systems for transferring data to mobile communication devices such as mobile telephones, using a media receiver device such as a set top box coupled to a broadcast media transmission network.

According to one aspect, the present invention provides a broadcast media receiver comprising:

a receiver unit for receiving a first data stream of broadcast media and at least one second data stream over a first communication channel;

data separation means for separating the second data stream from the first data stream;

a transmitter/receiver unit for communicating with mobile communication devices within a local, short range, transient wireless network using a second communication channel;

a monitoring device for detecting a mobile communication device present on the local wireless network, and for determining a device type and/or configuration thereof; and

a delivery device for delivering a third data stream, comprising at least part of said second data stream, to said mobile communication device according to the determined device type and/or configuration.

According to another aspect, the present invention provides a broadcast media transmitter comprising a transmitter unit for transmitting a first data stream of broadcast media and at least one second data stream, over a broadcast communication channel, to a plurality of broadcast media receivers (30), the at least one second data stream including at least one flag indicating a class of mobile communication devices to which at least a part of the second data stream relates.

According to another aspect, the present invention provides a mobile communication device comprising:

a transmitter/receiver unit for communicating with a broadcast media receiver in a local, short range, transient wireless network using a second communication channel;

means for receiving, from the broadcast media receiver, a request for identification of a device type and/or configuration of the mobile communication device;

means for responding to said broadcast media receiver with an indication of the device type and/or configuration of the mobile communication device; and

means for receiving a data stream from the broadcast media receiver customised to said indicated device type and/or configuration.

According to another aspect, the present invention provides a method of downloading data to a mobile communication device over a broadcast media network comprising the steps of:

receiving, at a broadcast media receiver, a first data stream of broadcast media and at least one second data stream over a first communication channel;

separating the second data stream from the first data stream;

communicating with one or more mobile communication devices within a local, short range, transient wireless network using a second communication channel;

detecting a mobile communication device present on the local wireless network, and determining a device type and/or configuration thereof; and

delivering a third data stream, comprising at least part of said second data stream, to said mobile communication device according to the determined device type and/or configuration.

Embodiments of the present invention will now be described by way of example and with reference to the accompanying drawings in which:

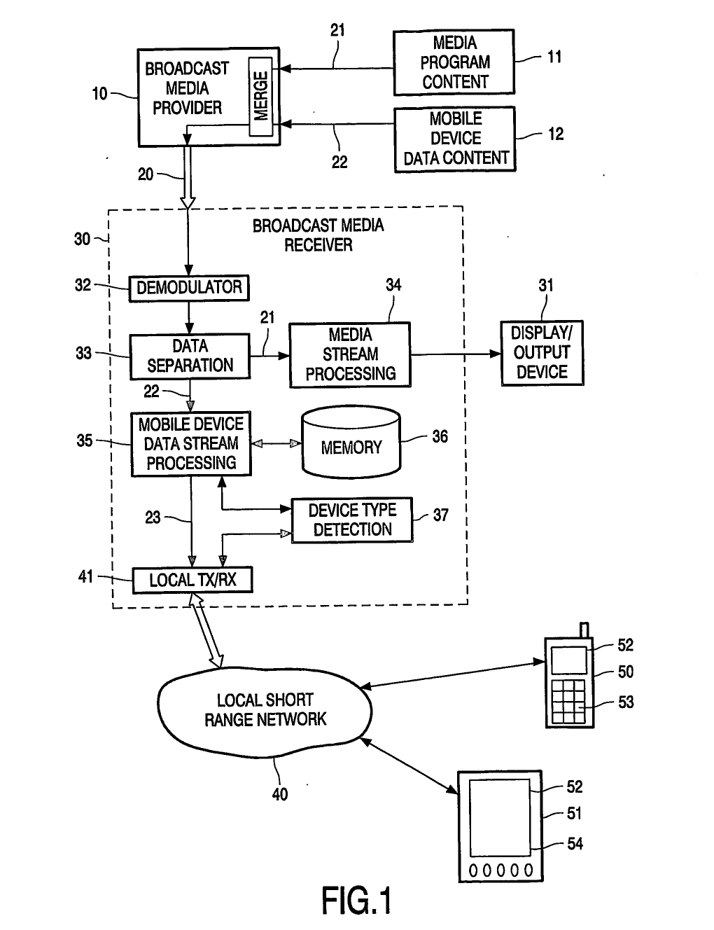

FIG. 1 shows a broadcast media receiver and associated network communication channels to a broadcast transmitter and mobile communication devices.

In the present invention, a broadcast media network is used as a conduit to deliver applications and other data to a mobile communication device, making use of the high bandwidth conventionally associated with such broadcast media channels.

With reference to FIG. 1, a broadcast media provider 10 receives media programming content such as television and radio channels from a media program content source 11 for transmission to a number of subscribers over a conventional broadcast media network communication channel 20, also described herein as the first communication channel.

The media programming content is described herein as a first data stream 21 and generally corresponds to program content for media output devices such as televisions and radios. At the same time, a second data stream 22 comprising data suitable for use by a number of possible recipient devices other than television and radio receivers is also provided by a second content source 12. The second data stream is merged with the first data stream for transmission to the subscribers over the first communication channel 20.

The second data stream may comprise software commands, application programs, data and other information content particularly for use in a mobile communication device such as a mobile telephone device 50 or a personal digital assistant 51.

The first communication channel 20 may use any suitable medium for conveying information in digital or analogue form, eg. radio, microwave, fibre-optic or co-axial cable link. The first communication channel 20 may use any suitable data transmission standard for distribution of digital data including simple continuous data streams, eg. DVB data piping or the MPEG DSMCC object carousel, DVB-S, DVB-T or DVB-C.

The first and second data streams 21, 22 are received by a broadcast media receiver 30 over the first communication channel 20. The media receiver 30 may take the form of a satellite receiver, terrestrial television receiver, set-top box, DAB receiver or the like. In a preferred arrangement, the media receiver 30 may be a multimedia home platform (MHP) system.

The media receiver 30 may incorporate or form part of a suitable display 31, for example an IDTV (integrated digital television) or a suitable record/playback device such as a DVD or hard disk drive recorder. Alternatively, the media receiver 30 may be a stand alone unit for connection to a suitable display device 31 such as a conventional television set or computer monitor.

In the illustrated embodiment, the media receiver 30 includes a demodulator 32 for extracting digital information signals from the signal broadcast over the first communication channel 20, according to known principles. The signals may be encrypted or open access. If the signals are encrypted, a decoder unit (not shown) will be provided to decrypt the signals according to known principles.

The media receiver includes a processor 33 for extracting or separating the second data stream from the first data stream. This may be achieved in a number of ways effective for the purposes of the present invention.

For example, in one arrangement, the first and second data streams may be completely separated from one another by the processor 33 such that first data stream 21 alone is passed to a suitable media stream processing device 34 for processing the data stream for output device 31.

In another example, the second data stream 22 may be ‘copied’ or extracted out of the combined data stream received over communication channel 20 leaving the original signal substantially unchanged for onward transmission to the media stream processing device 34. In this latter case, the media stream processing device 34 may or may not be capable of using the second data stream still embedded with the first data stream, for example in the case of video text data.

In either case, the extracted second data stream 22 is passed to a processor 35. Processor 35 is adapted to generate a third data stream, from the second data stream, which third data stream is customised or specially adapted for use in particular class of mobile communication devices 50, 51.

In one arrangement, processor 35 acts as a simple filter to remove all information from the second data stream which is not usable by the mobile communication device for which it is destined. For example, the processor may operate to remove all commands in the second data stream which are not supported by the class of mobile communication devices for which the data stream is intended.

In another arrangement, the processor 35 is programmed to convert, modify or otherwise adapt data in the second data stream specifically to customise the data stream to one or more different classes of mobile communication device 50, 51. For example, where the second data stream comprises an application program for use by a mobile communication device, the processor 35 may convert a generic version of the application program into one or more platform specific versions of the application program for onward transmission to one or more different classes of device.

The conversion software for the processor 35, enabling conversion of the second data stream into the third data stream may itself be downloaded from the broadcaster in the second data stream.

In one arrangement, the media receiver 30 may be provided with a memory 36 for storage and/or buffering of second and/or third data streams so that conversion and/or onward transmission of the data streams need not occur in real time.

Communication between the media receiver 30 and the mobile communication devices 50, 51 is effected by a local, short range wireless network 40. This is also described herein as the second communication channel. The second communication channel 40 may be provided according to the Bluetooth or IEEE 802.11 standards, or may be any other suitable local wireless network using, for example, radio or optical/infrared transceivers.

For this purpose, the media receiver 30 includes a transmitter/receiver unit 41 for communicating with the mobile communication devices 50, 51 using the second communication channel 40 according to known principles.

In order to establish a class of mobile communication device 50, 51 with which the media receiver 30 is communicating over the second communication channel 40, the media receiver 30 includes a device type detection unit 37. This interrogates the mobile communication devices 50, 51 detected on the local wireless network 40 to establish one or more of device type or device configuration.

The device type may include one or more of a mobile telephone, a personal digital assistant, a portable computer, a personal audio or video playing apparatus or a hybrid of any of these. The device configuration may include parameters relating to one or more of a processor configuration, an operating system, a display configuration, an application program executing or executable on the mobile communication device, a programming language executing or executable on the mobile device, a set of user defined preferences, proprietary standard or device attribute, or a combination of any of these.

The mobile communication devices 50, 51 preferably couple to the local wireless network 40 in a transient fashion, establishing a connection as and when the mobile device comes into range of the media receiver 30. The connections may be established automatically, or they may be user initiated and/or confirmed, or they may be automatically initiated by the media receiver with or without confirmation by the user.

Each mobile communication device preferably includes a display 52, a user keypad 53 and/or touchscreen 54 and a memory for storing data and applications programs downloaded from the media receiver 30. As shown in FIG. 1, the mobile communication device may be a mobile telephone 50 or a personal digital assistant 51.

In one exemplary mode of operation, the broadcast media provider 10 transmits a specific application program for use by one or more classes of mobile telephone 50. Together with a first data stream 21 comprising media programming content, the application program is transmitted within a second data stream 22 over the broadcast channel 20.

The media receiver 30 extracts the second data stream 22, and by reference to flags therein or associated therewith, identifies the class or classes of mobile telephone with which the specific application program is compatible.

The media receiver establishes which ones of mobile devices connected to its local wireless network 40 are of the relevant class for that specific application program and forwards the extracted application program thereto as a third data stream.

In another exemplary mode of operation, the broadcast media provider 10 transmits, a generic application program for use by many classes of mobile telephone 50 or other mobile device. Together with a first data stream 21 comprising media programming content, the generic application program is transmitted within a second data stream 22 over the broadcast channel 20. The media receiver 30 extracts the second data stream 22. The media receiver establishes the classes of devices connected to its local wireless network 40 and converts the generic application program into a specific application program customised for use by the identified device on its local wireless network. It forwards the converted application program thereto as a third data stream.

In another exemplary mode of operation, the media receiver 30 receives a plurality of application programs, data or other commands destined for use by one or more classes of mobile device 50, 51 in the second data stream and stores these in memory 36. Memory 36 may be routinely updated with such second data streams as they come around on a broadcast data carousel. Mobile devices transiently connected to the wireless network 40 are then identified by class of device by the media receiver 30, which initiates conversion of programs and data to a customised format for the detected class of mobile device and download of those programs and data to the mobile device as third data streams over the wireless network 40.

In one mode of use, the second data stream comprises data presented in a particular content format, such as HTML. The media receiver converts this content format to one which is suited to the recipient mobile device, such as WML.

In a preferred arrangement, the application programs may comprise Java applications that can be executed on an MHP platform, and these may be converted, by the media receiver, to an MIDP implementation suitable for use by mobile telephones.

A further exemplary mode of operation will now be described.

The broadcast network may consist of one of the DVB standards for digital TV transmission (eg. DVB-S, DVB-T, DVB-C). The second data stream may be delivered as a set of private sections on a dedicated PID (process identifier).

The media receiver may be a MHP-enabled STB with a Bluetooth module. An additional set of APIs for access to the Bluetooth network is included on the device (the JSR-82 API).

A Bluetooth enabled mobile phone may be present on the local wireless network. The device will process a set of extended Hayes AT commands. These commands control most aspects of the mobile telephone, including dialling numbers on the telephone network and the contents of the display on the mobile telephone.

The broadcaster may inject private sections containing the mobile telephone application data into a broadcast at a certain bit rate. The SI signalling in the broadcast is augmented by adding a new entry in the PMT table for the TV channel being broadcast describing which PID the private sections are being delivered on. A new MHP AIT table is broadcast with an application type for the particular type of mobile device being targeted and the data protocol used.

The media receiver may have a resident application which is started on reception of the new AIT. The application uses the device location and service discovery features of the Bluetooth API to locate the mobile telephone. A data channel to the mobile device is opened.

The application then starts monitoring the private sections. On reception of each section, it processes the data if necessary and forwards the results over the Bluetooth data channel. Processing may occur to filter out functions that the mobile device does not support or to suppress certain commands for security reasons (eg. to block outgoing calls). If the Bluetooth network configuration changes later, the application responds by breaking down the old connections and opening new ones.

In another exemplary mode of operation, after download of applications and data to the mobile communication device 50, 51, the application may interact with the media receiver to access further information from the broadcast network, with data processing occurring on both the media receiver and the mobile communication device.

Some exemplary applications include:
1) Delivery of an electronic program guide to the mobile device to allow a single viewer to browse TV listings without obscuring the TV display. Selection of items on the display of the mobile device may then cause channel selection on the TV.
2) Selection of mobile telephone applications to download to the mobile telephone from the broadcast channel. The user interface for this menu could appear on either the mobile device or on the TV display.
3) Download of the currently running Java application on the STB to the mobile device.
4) Retargeting of media from the broadcast channel for display on the mobile device. This could include transcoding MPEG-2 broadcasts to low bit rate MPEG-4 within the media receiver.
5) Use of the mobile device display 52 as a display surface for the STB device. The MHP application resident in the STB may then draw directly to the display on the mobile device.

The invention has application in both domestic and non-domestic environments.

Other embodiments are intentionally within the scope of the accompanying claims.

1. A broadcast media receiver (30) comprising:
a receiver unit for receiving a first data stream (21) of broadcast media and at least one second data stream (22) over a first communication channel (20);
data separation means (33) for separating the second data stream (22) from the first data stream (21);
a transmitter/receiver unit (41) for communicating with mobile communication devices (50, 51) within a local, short range, transient wireless network (40) using a second communication channel;
a monitoring device (37) for detecting a mobile communication device present on the local wireless network, and for determining a device type and/or configuration thereof; and
a delivery device (35, 41) for delivering a third data stream (23), comprising at least part of said second data stream (22), to said mobile communication device according to the determined device type and/or configuration.

2. The broadcast media receiver of claim 1 further including a processor (35) for converting the at least part of the second data stream (22) into the third data stream (23) such that the third data stream is in a format suitable for the determined device type and/or configuration of the mobile communication device (50, 51).

3. The broadcast media receiver of claim 1 in which the third data stream (23) comprises any one or more of commands, an application program, or other data.

4. The broadcast media receiver of claim 1 in which the delivery device (35) is a filter adapted to remove any parts of the second data stream (22) that are incompatible with characteristics of the determined device type and/or configuration of the mobile communication device (50, 51).

5. The broadcast media receiver of claim 1 in which the second data stream (22) includes identifiers indicating a predetermined class of devices for which parts of the second data stream are suitable and the data separation means (33) is adapted to process said second data stream to extract respective parts thereof according to each identifier for a class of devices.

6. The broadcast media receiver of claim 1 in which the delivery device (35) automatically forwards the third data stream (23) to all mobile communication devices (50, 51) on the local wireless network having the determined device type and/or configuration.

7. The broadcast media receiver of claim 1 in which the monitoring device (37) is adapted to detect a device type corresponding to one or more of a mobile telephone, a personal digital assistant, a portable computer, a personal audio or video playing apparatus, or a hybrid of any of the above.

8. The broadcast media receiver of claim 1 in which the monitoring device (37) is adapted to detect a configuration of the mobile communication device (50, 51) in which configuration parameters include one or more of a processor configuration, an operating system, a display configuration, an application program executing or executable on the mobile communication device, a programming language executing or executable on the mobile device, a set of user defined preferences, a proprietary standard or device attribute, or a combination of any of the above.

9. The broadcast media receiver of claim 1 in which the data separation means (33) includes means for detecting, within said second data stream, one or more flags indicating a class of devices to which at least a part of the second data stream relates.

10. The broadcast media receiver of claim 1 in which the delivery device (35, 41) is adapted to deliver the third data stream (23) to the mobile communication device (50, 51) over the second communication channel (40).

11. The broadcast media receiver of claim 1 in which the transmitter/receiver unit (41) is adapted to use a Bluetooth or IEEE 802.11 communication standard.

12. The broadcast media receiver of claim 1 further including a processor (35) for executing an application program interactively with an associated mobile communication device (50, 51) following download of relevant parts of that application program to the mobile device as said third data stream (23).

13. The broadcast media receiver of claim 1 further including means (37) for periodically checking for the existence of new mobile communication devices (50, 51) within the wireless network (40).

14. A broadcast media transmitter (10) comprising a transmitter unit for transmitting a first data stream (21) of broadcast media and at least one second data stream (22), over a broadcast communication channel (20), to a plurality of broadcast media receivers (30), the at least one second data stream (22) including at least one flag indicating a class of mobile communication devices (50, 51) to which at least a part of the second data stream relates.

15. The transmitter of claim 14 in which the transmitter unit is adapted to transmit a plurality of said second data streams, each one including a flag indicating a class of devices to which the respective second data stream relates.

16. The transmitter of claim 14 or 15 in which the class of devices so indicated is one or more of a mobile telephone (50), a personal digital assistant (51), a portable computer, a personal audio or video playing apparatus, or a hybrid of any of the above.

17. A mobile communication device (50, 51) comprising:
a transmitter/receiver unit for communicating with a broadcast media receiver (30) in a local, short range, transient wireless network (40) using a second communication channel;
means for receiving, from the broadcast media receiver, a request for identification of a device type and/or configuration of the mobile communication device;
means for responding to said broadcast media receiver with an indication of the device type and/or configuration of the mobile communication device; and
means for receiving a data stream from the broadcast media receiver customised to said indicated device type and/or configuration.

18. The mobile communication device of claim 17 in which the data stream comprises any one or more of commands, an application program, or other data.

19. The mobile communication device of claim 17 comprising any one of a mobile telephone, a personal digital assistant, a portable computer, a personal audio or video playing apparatus, or a hybrid of any of the above.

20. The mobile communication device of claim 17 in which the means for responding is adapted to indicate a configuration of the mobile communication device in which configuration parameters include one or more of a processor configuration, an operating system, a display configuration, an application program executing or executable on the mobile communication device, a programming language executing or executable on the mobile device, a set of user defined preferences, a proprietary standard or device attribute, or a combination of any of the above.

21. The mobile communication device of claim 17 further including a processor for executing an application program interactively with an associated broadcast media receiver following download of relevant parts of that application program to the mobile device from the broadcast media receiver.

22. A method of downloading data to a mobile communication device (50, 51) over a broadcast media network (20) comprising the steps of:
receiving, at a broadcast media receiver (30), a first data stream (21) of broadcast media and at least one second data stream (22) over a first communication channel (20);
separating the second data stream (22) from the first data stream (21);
communicating with one or more mobile communication devices within a local, short range, transient wireless network (40) using a second communication channel;
detecting a mobile communication device present on the local wireless network, and determining a device type and/or configuration thereof; and
delivering a third data stream (23), comprising at least part of said second data stream, to said mobile communication device according to the determined device type and/or configuration.

23. The method of claim 22 further including converting the at least part of the second data stream into the third data stream such that the third data stream is in a format suitable for the determined device type and/or configuration of the mobile communication device.

24. The method of claim 22 in which the third data stream comprises any one or more of commands, an application program, or other data.

25. The method of claim 22 further including filtering out any parts of the second data stream that are incompatible with characteristics of the determined device type and/or configuration of the mobile communication device to form said third data stream.

26. The method of claim 22 further including detecting identifiers within the second data stream indicating a predetermined class of devices for which parts of the second data stream are suitable and processing said second data stream to extract respective parts thereof according to each identifier for a class of devices.

27. The method of claim 22 further including the step of automatically forwarding the third data stream to all mobile communication devices on the local wireless network having the determined device type and/or configuration.

28. The method of claim 22 further including detecting a device type corresponding to one or more of a mobile telephone, a personal digital assistant, a portable computer, a personal audio or video playing apparatus, or a hybrid of any of the above.

29. The method of claim 22 further including detecting a configuration of the mobile communication device in which configuration parameters include one or more of a processor configuration, a display configuration, an application program executing or executable on the mobile communication device, a programming language executing or executable on the mobile device, a set of user defined preferences, or a combination of any of the above.

30. The method of claim 22 further including detecting, within said second data stream, one or more flags indicating a class of devices to which at least a part of the second data stream relates.

31. The method of claim 22 in which the third data stream is delivered to the mobile communication device over the second communication channel.

32. The method of claim 22 further including executing an application program interactively with an associated mobile communication device following download of relevant parts of that application program to the mobile device as said third data stream.

33. The method of claim 22 further including periodically checking for the existence of new mobile communication devices within the wireless network.

34. A computer program product, comprising a computer readable medium having thereon computer program code means adapted, when said program is loaded onto a computer, to make the computer execute the procedure of claim 22.

35. A computer program, distributable by electronic data transmission, comprising computer program code means adapted, when said program is loaded onto a computer, to make the computer execute the procedure of claim 22.
